(19) United States
(12) Patent Application Publication
(10) Pub. No.: US 2011/0105143 A1
(43) Pub. Date: May 5, 2011

(54) PROXIMAL RELEVANCY RANKING IN A LAYERED LINKED NODE DATABASE

(75) Inventors: Dan HARPLE, South Dartmouth, MA (US); Sam CRITCHLEY, Amsterdam (NL); Rich PIZZARRO, Mechanicsburg, PA (US); Gavin NICOL, Barrington, RI (US)

(73) Assignee: GEOSOLUTIONS B.V., Warwick, RI (US)

(21) Appl. No.: 12/611,636

(22) Filed: Nov. 3, 2009

(51) Int. Cl. H04W 24/00; G06F 17/30

(52) U.S. Cl. 455/456.1; 707/749; 707/E17.045

(57) ABSTRACT

A system and method for determining node relevancy by proximal weighting and pruning in a layered linked node database, such as that used to represent connections between a set of objects. The weights of connections between nodes in the layered linked node database is used as a distance metric, with propagation semantics determining how the summed relevancy is determined. This is particularly useful for determining, for a given node in a given layer, which nodes in another layer, or on the same layer, are most relevant. In the context of mobile device users, this is particularly useful for dynamically determining which people, places, events etc. are of greatest relevance in a scalable manner.

### CROSS REFERENCED TO RELATED APPLICATION

This application is related to the following applications, the entire contents of which are incorporated herein by reference:

U.S. patent application Ser. No. 12/510,854 filed Jul. 28, 2009, entitled “System for Enhanced Management of Social Networks on Mobile Devices;” and

U.S. patent application Ser. No. 12/510,866 filed Jul. 28, 2009, entitled “System for Creation of Content with Correlated Geospatial and Virtual Locations by Mobile Device Users.”

### FIELD OF THE INVENTION

The present invention relates generally to node ranking in a layered linked node database, and more specifically to a system and method for dynamically determining node relevancy based on proximal weighting within and between layers, in a scalable manner.

### DESCRIPTION OF THE BACKGROUND ART

There is a rapidly accelerating growth in the use of the world wide web and other computer systems to access information about people and places. There is also a rapidly accelerating growth in the use of mobile devices, and in particular, mobile devices that have the ability to derive the current location of the user. There is a further trend for mobile devices to provide functionality to access the full Internet, including, but not limited to, web sites. These trends have combined to create a rapidly growing number of mobile devices supporting full access to the Internet, for mobile device users to increasingly regard the mobile device as the primary device that is used to access information, and for the device they are using to know where the user is at a given point in time.

As these trends accelerate, they are changing the expectations that mobile device users have. In the past, mobile device users tended to regard mobile devices as largely static convenience devices that allowed them to make telephone calls, or to send text messages, at will. Increasingly, as the devices become more central to the life of the mobile device user, the mobile device is used to store more intimate information about the user. This has the effect of changing the mobile device users' perception of the device, from something static and impersonal, to something dynamic and personal. In other words, as the mobile device user imparts more knowledge about themselves to the device, mobile device users increasingly expect the device to know more about them, and to leverage that information to aide the mobile device user.

Until the present invention, technologies did not meet all of the expectations of all mobile device users. The greatest mismatch between functionality and expectations is due to the limitations of the mobile devices in dealing with the context in which a mobile device user is operating. As a mobile device user moves through their day, the context in which they are operating continually changes: their location changes, and the people and places with which they are interacting change. Current devices and online services supporting them cannot deal adequately with these continuous context changes.

As the mobile device user's context changes, so does the relevancy of the things around them. As a simple example, if a mobile device user travels to another city, intuitively, the restaurants around them are likely to be of greater relevance than restaurants many miles away. This may not always be the case: the mobile device user may be doing research about restaurants, in which case, the mobile device context reflects some change of interest, and hence relevancy (by changing into a ‘search’ context, the system naturally reflects a difference in relevancy). A system needs to be able to dynamically adapt to such changes.

The notion of proximal relevancy can be found in almost everything mobile device users do. For geospatial distances, the research is clear: for the most part, people do not consider places more than 16 miles away to be of any immediate relevance (Candia 2008, Gonzalez 2008). A similar pattern is also found in online social networks: studies (Wassermanl 995, Zeigler 2005, Rocha, Hill, Kumar) have shown that most people have less than 150 online friends, and generally less than 7 close friends that they are constantly in contact with. Other studies have shown that the relevance or ‘value’ of a relationship decreases rapidly as the number of people between one person and another increases (inverse of the 6 degrees effect). While there are a large number of things in which a mobile device user may be interested, at any given point in time, the true number of relevant items is actually fundamentally limited (Dunbar 1992, Dunbar 1993, Murata 2007, Sawa 1990).

As noted earlier, current mobile devices do not meet mobile device user expectations for contextual relevancy, and neither do current search technologies. While search engines may, or may not, provide a means to restrict search results to within a given geospatial proximity, such restrictions are typically handled as a special case, and not as an intrinsic part of the search engine. A good example is the Google search engine, which uses the well-known PageRank algorithm to statically determine the relevancy of a particular set of pages: proximity restrictions are layered over the underlying ranked link database as a filtering, or sorting based on proximity. Other relevancy restrictions, such as social relevancy, would likewise be layered over the underlying, static weighted node database.

### SUMMARY OF INVENTION

A key factor of the present invention is to look at mobile device users, and their relationship to the world, as a set of weighted connections that are constantly changing, and to realize that proximity in connections is crucial. The problem of making mobile devices more personal then becomes a problem of maintaining, in real time, a set of weighted connections between items and mobile device users. By storing the nodes and connections in a layered linked node database, and then using this database, and user context to determine relevancy of nodes within the database, it is possible to provide a more dynamic, and personal view to mobile device users.

Aspects of the present invention provide a system and method for assigning a relevance ranking to nodes in a layered linked node database. Aspects of the present invention have a number of benefits over previous systems and methods, including, but not limited to, a means to use the link structure within a layered linked node database to determine relevancy, a more natural derivation of relevancy, especially from the viewpoint of a human user, a means to dynamically determine relevancy, taking into account the most recent changes to the layered linked node database, a system that can scale to extremely large databases, and a structure allowing the relevancy to be updated in near real time.

Aspects of the present invention use a layered linked node database to determine relevancy. A layered linked node database consists of a number of layers, an example of which is shown in FIG. 1, where there are a plurality of layers, Geospatial, Place, and Space. Each layer has a set of nodes with connections between them such that each layer forms a graph. Connections may also exist between layers, forming another graph. This structure is more complex than typical node databases used for determining node ranking, and provides opportunities to more accurately determine a true relevancy ranking for a node.

Aspects of the present invention use the link structure of a layered linked node database to derive a relevancy ranking for nodes based on proximal weighting. There may be a plurality of layers, each with its own connection structure and weighting factors. It should be clear to those skilled in the relevant art that there are any number of possible layers and connection patterns within and between them. The ranking of a particular node is determined by propagating a value between and within layers in the layered linked node database.

In the context of FIG. 1, which shows three layers, Geospatial (physical location), Place (virtual location) and Space (social network), intuitively, direct social connections are generally of more relevance to a given person, than indirect connections. Likewise, Place data (virtual location) created by a user is generally of more relevance than Place data created by unknown people. Further, geospatial locations that are referenced by, or related to, direct social connections, or Place data created by them, is generally of more relevance than arbitrary geospatial locations. As such, in the context of FIG. 1 a layered linked node database is created to reflect the connections, and a node ranking is determined from this layered linked node database, which more naturally reflects the relevance to mobile device users.

Note that in general, relevancy is determined using a per-layer and inter-layer weighting scheme, and that by altering the starting node set and the damping scheme different effects can be achieved. For example, in the context of FIG. 1, if the inter-layer weighting were set to 0, then relevancy ranking would occur only within a particular layer. This can be used to determine, for example, only ‘nearby places’ at the Geospatial layer, or ‘close friends’ at the Space layer. As a further example, assuming the connection between 2 users was set to 0, the effect in terms of determining the most relevant geospatial locations for a given user would immediately reflect the change in relevance of locations with direct connections to one of the two users. This flexibility in retrieval is significant to aspects of the present invention.

Those skilled in the relevant art will also understand that extant relevancy ranking schemes, such as PageRank, determine relevancy for all nodes based on link structures and do so statically by performing an analysis of all nodes and arcs at once, thereby producing a static ‘snapshot’ of node relevancy. While aspects of the present invention may be used to determine relevancy in a static manner, for all nodes, it is neither necessary nor sufficient for processing the dynamic changes to relevancy that occur naturally. As such, aspects of the present invention emphasize, but are not limited to, a dynamic determination of relevancy that immediately takes updates to the layered linked node database into account.

Some aspects of the present invention further require only local updates to the layered linked node database in order to dynamically alter the relevancy ranking of nodes. As noted earlier, setting the inter-layer connection weight to 0 will result in no nodes from other layers being included in the ranking. Due to the emphasis on dynamic determination of node relevancy in the present invention, local changes such as this have an immediate impact. By only requiring local updates, aspects of the present invention are far more scalable and dynamic than comparable systems.

Some aspects of the present invention further provide a structure that can be updated in close to real time, even for large graphs, thereby providing a level of dynamic behavior hereto unavailable in large linked databases. With only local updates being required, literally thousands of updates to the layered linked node database could occur per second, with effects of updates being immediately apparent.

One embodiment of the present invention can be used in a system that statically assigns a node ranking to all nodes in layered linked node database, thereby providing a global node ranking mechanism. The global ranking may be used to determine, in the absence of restrictions or context, the most highly valued nodes within the database. This is similar to extant node ranking mechanisms, such as PageRank in that it produces global static weightings, though the present invention uses a somewhat different mechanism for determining the weights.

A further embodiment of the present invention can be used in a system to dynamically determine relevance for a particular set of nodes, or a particular context. For example, the system may be used to determine the most relevant restaurants for a mobile device user when they are at a given location at a given point in time. Such a system will dynamically take into account past preferences and current location in the determination of relevancy.

A further embodiment of the present invention can be used in a system for categorization based on relevancy, such as clustering of news articles. For example, each news article can be taken as a node, with links between nodes and node features. The weighting mechanism described herein will cluster the nodes based on distance metrics. Higher level features, such as ‘category,’ and lower-level features, such as term frequency and term proximity weightings can also be incorporated. With such a system, the clustering would ‘evolve’ over time, possibly incorporating feedback from users to indicate ‘true’ relevance clusterings.

Yet another embodiment of the present invention can be used in a system that will learn relevance, and dynamically take temporal affinity into account. For example, if a mobile device user has searched for restaurants, and historically has had a preference for Japanese food, but most recently, has always expressed interest in Chinese food, the system would automatically weight Chinese restaurants higher.

Yet another embodiment of the present invention can be used in a system that can determine node relevancy based on geospatial filtering or other forms of proximal filtering. For example, a system might provide a means to rank nearer restaurants higher than restaurants further away.

Other embodiments and systems that are compatible with the description and claims of the present invention are possible. Those skilled in the relevant art will appreciate the flexibility and large number of potential applications of the present invention.

### BRIEF DESCRIPTION OF DRAWINGS

FIG. 1 shows an example of a set of nodes and connections that might be stored in a layered linked node database.

FIG. 2 shows another example of a set of nodes and connections that might be stored in a layered linked node database.

FIG. 3 shows an example of a connection set with connections and weights associated with them.

FIG. 4 shows an example of a connection set within a given layer with nodes (A thru E) and connections between nodes (C1 thru C4) along with a propagated value.

FIG. 5 shows a more detailed graph, including weight values before the application of the techniques from the present invention.

FIG. 6 shows a more detailed graph, including weight values and node rankings, after application of techniques from the present invention.

FIG. 7 outlines the basic mechanism used to perform node rankings

FIG. 8 shows the main conceptual parts of the present invention.

### DETAILED DESCRIPTION

In the following description the present invention will be described using specifics for illustrative purposes. Those with skill in the relevant art will immediately appreciate that there are large number of variations possible that still lie within the purview of the present invention. In particular, the present invention is described in the context of a particular layered linked node database, while being generally applicable to linked node databases of arbitrary structure. Furthermore, the following description focuses on use in the context of mobile devices, but as those skilled in the relevant art will appreciate, the present invention is applicable to other domains.

The problem of determining what is relevant to a user of a mobile device at a given point in time can be broken into two major parts: naturally modeling the items a mobile device user interacts with, and naturally modeling and manipulating the relationship between these items. The term ‘item’ is used to refer to an arbitrary, identifiable entity, such as, but not limited to a contact, an establishment such as a bar, restaurant, or museum, a geospatial location or virtual items representing abstract concepts, such as Japanese food, skiing or education. Being able to naturally and consistent manage relationships to both physical and virtual items is significant to aspects of the present invention.

One way to naturally represent items and the relationship between them, is as a graph G={V,E}, wherein each node (vertices, or V) represents an item, and arcs (edges, arcs or E) between nodes represent a relationship. For the purposes of determining relevancy, many systems associate a weight to the edge indicating some strength of connection. By altering the topology and semantics of the arcs connecting the vertices, it is possible to created a layered structure, thereby creating a layered linked node structure, or layered linked node database. There may be a plurality of layers, each with its own connection structure within and between layers.

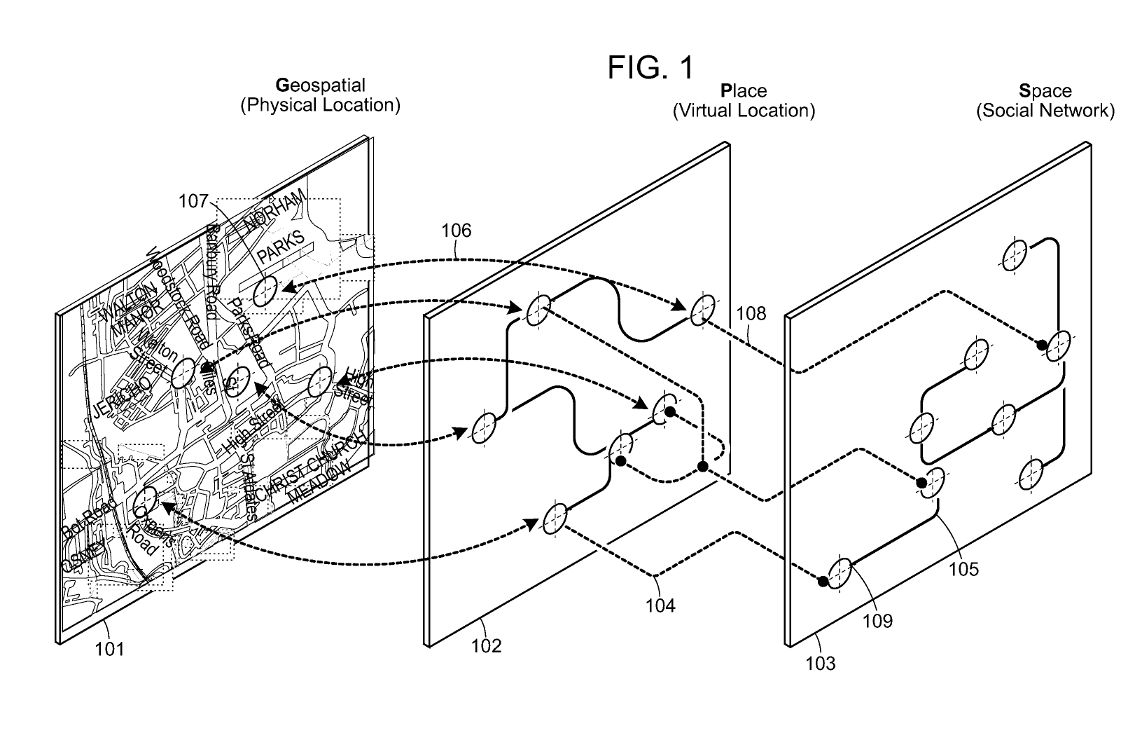

A typical layered linked node database is shown in FIG. 1. In this particular case the database is comprised of 3 layers: Geospatial 101, Place 102 and Space 103. The Geospatial layer 101 represents physical locations 107. The Place layer 102 represents a virtual node structure that describes geophysical locations as indicated by the arcs 106 between nodes 108 in the Place layer and nodes 107 in the Geospatial layer. The Space layer 103 represents social network nodes 109, connections 105 between nodes in the same layer, and connections 104 between nodes in different layers. It should be clear to those skilled in the relevant art that there are any number of possible layers and connection patterns within and between them.

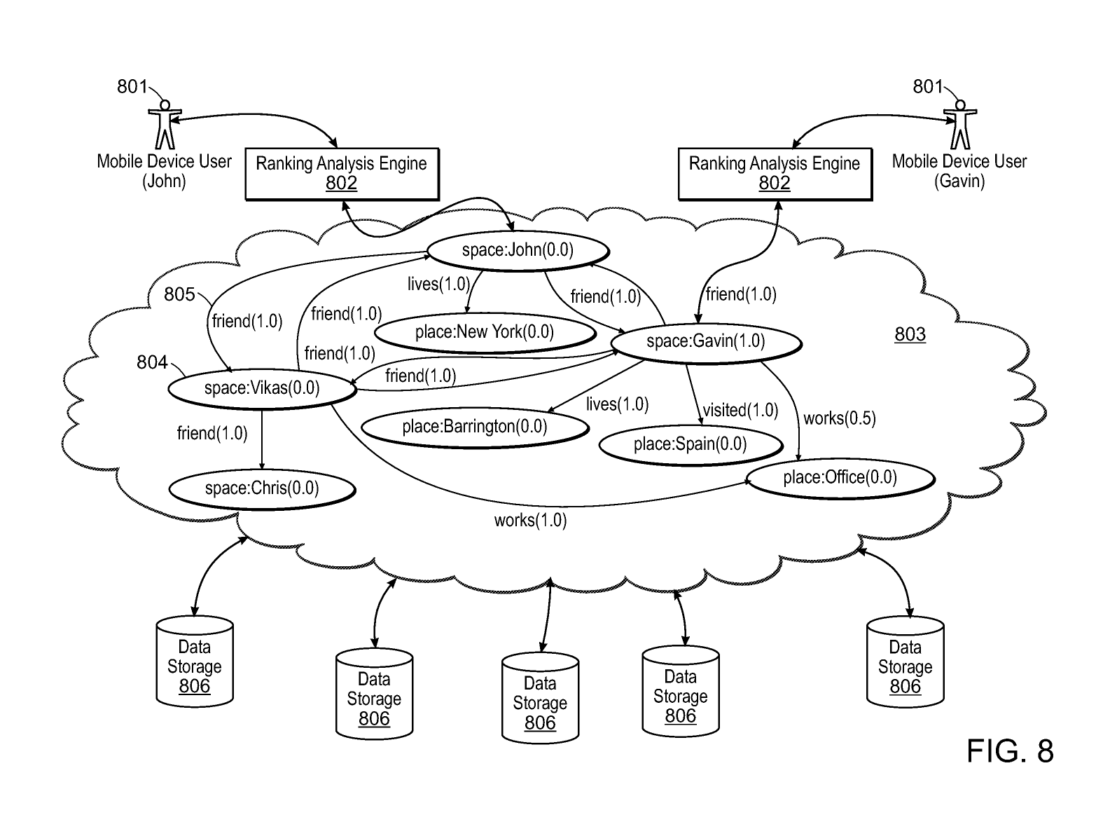

In an embodiment of the present invention, the nodes and connections would be stored in a database, such as a relational database management system (RDBMS), where each node and connection would be associated with a unique identifier used for identification and retrieval, and could have one or more associated properties, such as name, or in the case of connections, weights. In the preferred embodiment of the present invention a single RDBMS may not be used as the primary data store because, as those skilled in the relevant art will recognize, this will face scalability issues with large graphs. In the preferred embodiment of the present invention, as shown in FIG. 8, the graph will instead be partitioned, or ‘sharded’, across one or more Data Storage units 806, and the graph will be kept largely in a distributed virtual database 803.

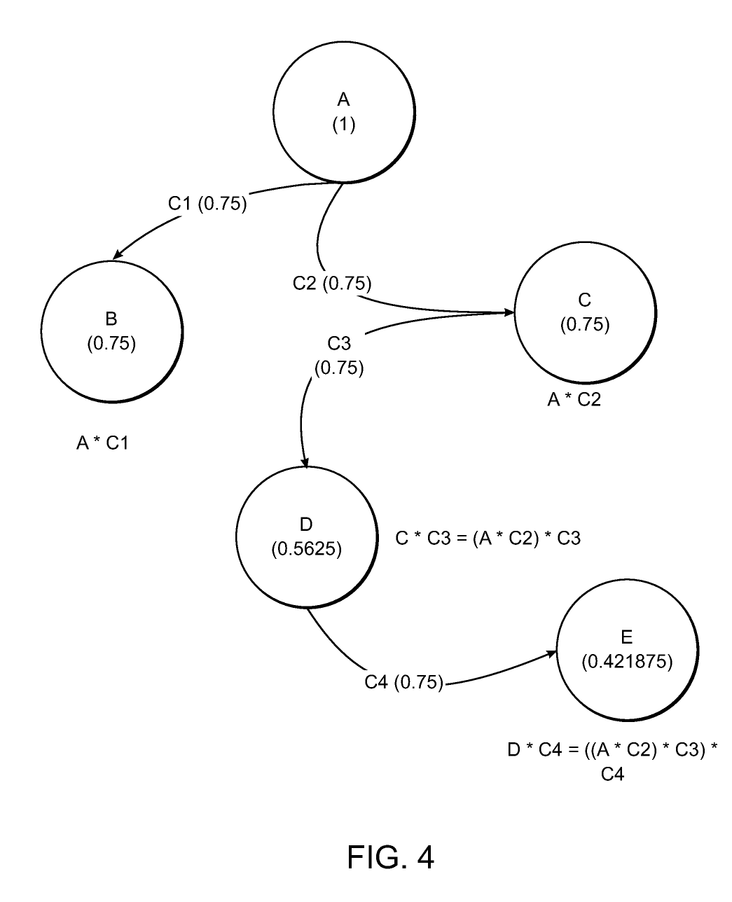

Aspects of the present invention use the link structure of a layered linked node database to derive a relevancy ranking for nodes based on proximal weighting. The node ranking is determined by a simple sum of values propagated through weighted connections. An example of the summation is shown in FIG. 4, where (A) is regarded as the ‘starting point’. As the value of (A) is propagated through the graph, the value of the next node is taken as the product of the current node and the weight of the connection between it and the next node, hence node (B) has a value of 0.75, and D has a value of 0.5625. This has the effect of producing rank weightings that are a factor of proximity.

The graph may be directed, or undirected, the primary difference being that in an undirected graph, there will be a bidirectional connection between vertices, so that the undirected graph would be equivalent to a directed graph with an arc in both directions with the same weight.

Taking the definition of the graph earlier (G={V,E}), the graph comprises a set of vertices V, and a set of arcs E. Another way to look at this is that there is a list of vertices V₁ thru Vₙ and that the arcs are an n×n matrix of weights, such that E_{1,n} would be the weight of the arc from V₁ to Vₙ. If the graph is undirected, the weights would be symmetrical (E_{1,n} would equal E_{n,1}), but whether the graph is directed or undirected, a lack of a connection would be represented by the value 0. Given such a representation, the value for a given node N is given as the sum of values feeding into N, or by the equation

$${N}_{i} = {\sum }_{j} {E}_{ij} {N}_{j}$$

where E is the weight matrix. As noted earlier, layers in the layered linked node database are defined through the graph topology.

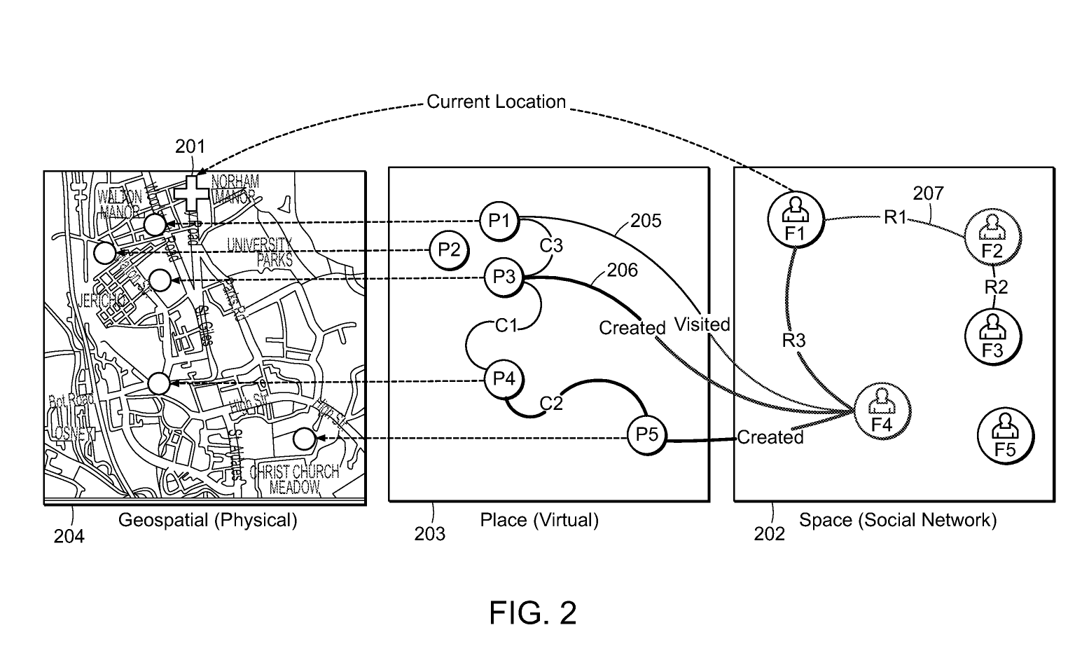

Note that there may be other more or less specific derivative equations that can be used to determine node relevancy. For example, assuming the layered linked node database structure as shown in FIGS. 1 and 2, a more specific equation that explicitly takes layers into account could be given as

$${N}_{i} = G \times {\sum }_{j} {P}_{j} {E}_{ij} + {S}_{j} {E}_{ij}$$

where G is a weighting factor based on the geospatial distance and P and S represent nodes in the Place 102 and Space 103 layers with an assumed starting value of 1.0. Those skilled in the relevant art will appreciate that there a large number of possible derivative, but equivalent equations.

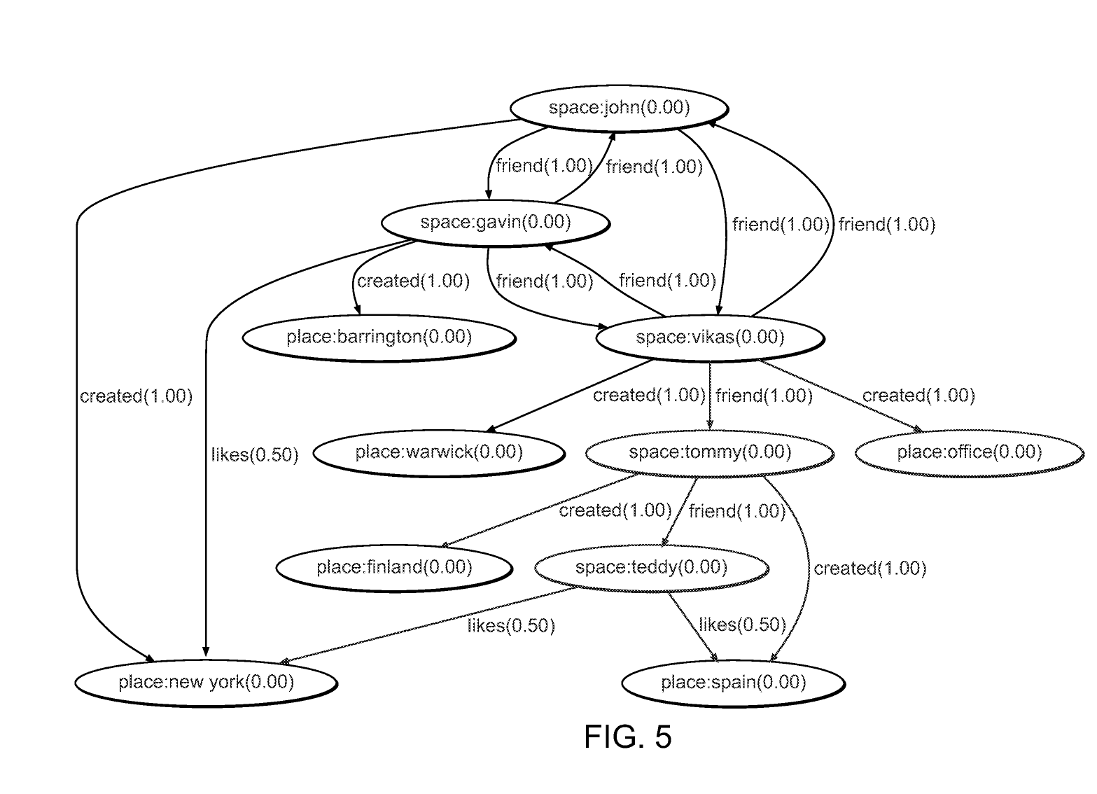

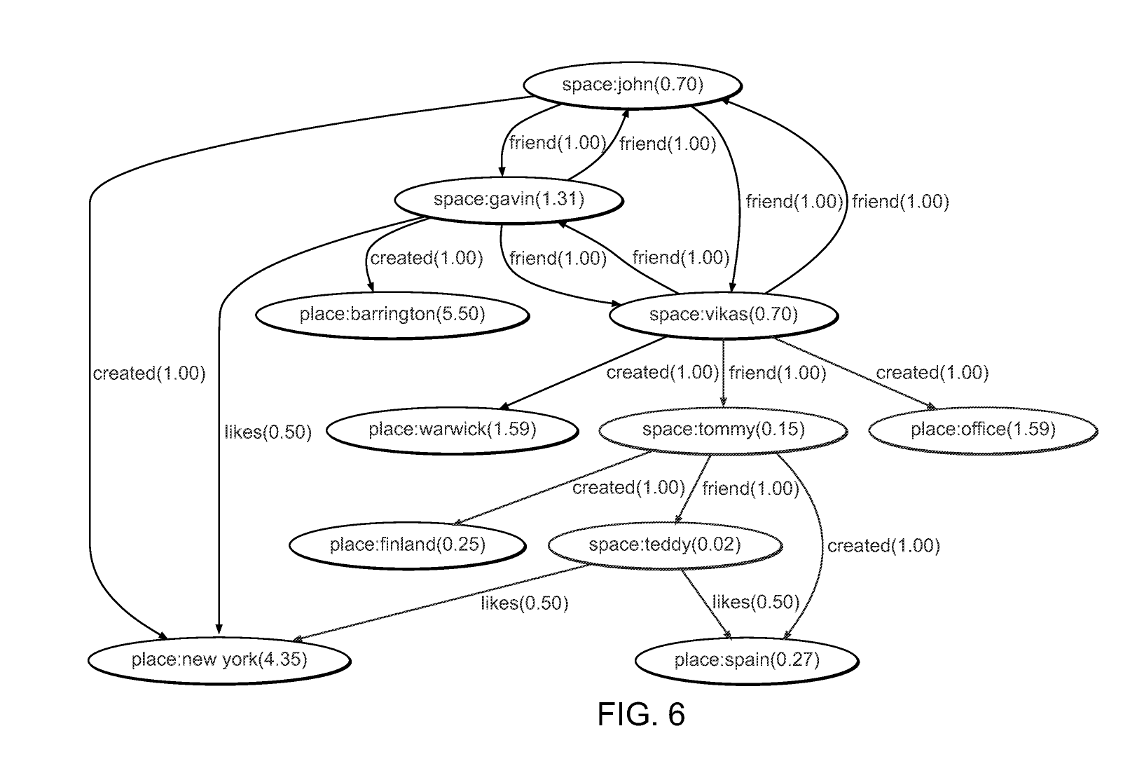

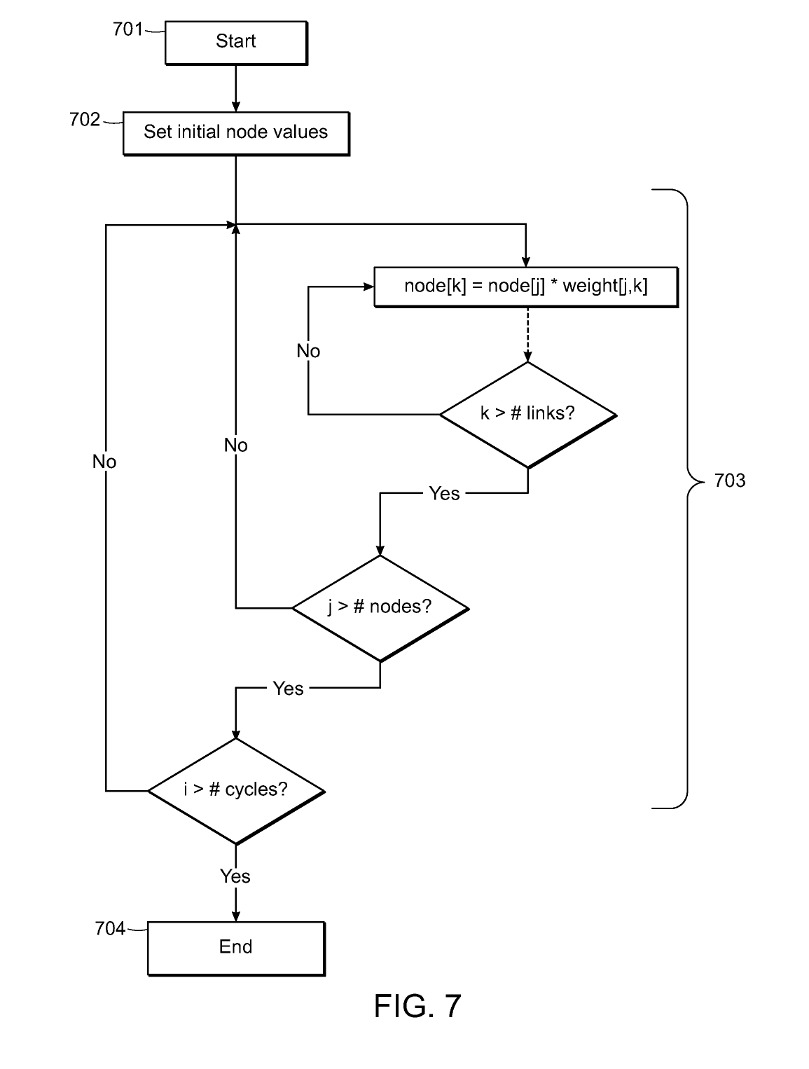

The general update mechanism is shown in FIG. 7. At the opening stage 701 the nodes in the graph are all assumed to have a value of 0. Starting with a particular set of one or more nodes, the nodes are given an initial starting value in 702. Then, in the update step 703 the values are propagated throughout the graph by taking the summed product of the value and the weights of connections from one node to another as a derived value for the node. The process is repeated a number of times in order to allow the values to fully propagate throughout the graph and for the values to ‘settle’. At the end of the process 704 the nodes most tightly linked to the starting nodes will have the highest values. FIGS. 5 and 6 represent a typical graph before and after application of the update mechanism.

A further normalization step may be applied to the nodes whereby each node value is calculated to fall within some range or otherwise transformed. A typical function to be applied to the node value is the logistic function

$$f ( N ) = \frac{1}{1 - {e}^{N}}$$

which will produce a sigmoid curve with the values falling between 0 and 1. This is especially useful if the update mechanism is used to determine the ranking for all nodes in the layered linked node database as it prevents node rankings from increasing or decreasing arbitrarily because of cycles in the graph, or overly represented weightings.

In the context of FIG. 8, the preferred embodiment will use multiple instances of the Ranking Analysis Engine 802 running concurrently over the distributed virtual database 803, one for each set of rankings being calculated, where each ranking has a different set of start nodes and different values assigned to the start nodes. In the preferred embodiment, each Ranking Analysis Engine 802 acts as a client of the virtual database 803, pulling node and link sets from the virtual database on an as-needed basis. Each of these Ranking Analysis Engines 802 will maintain the state of the rankings locally, thereby removing the necessity for managing global state.

A slight variant of the update mechanism may prioritize intra-layer updates over inter-layer updates. FIG. 2 shows a typical 3 layer database, with the Geospatial 204, Place 203 and Space 202 layers. The current location of user F1 is illustrated as physical location 201. The figure shows the inter-layer arcs 205 and intra-layer arcs 207. Some of the arcs are more highly weighted than others: for example, the user-created arcs 206 are more highly weighted than the user-visited arcs 205. For example, the arc between a user and a user-created item, such as a photograph taken by the user, is more highly weighted than an arc between the user and a user-visited item, such as a museum. Using an alternate update mechanism, each update cycle would first propagate the node values within a given layer, and then propagate the values between layers. For example, the nodes F1 thru F4 in Space layer 202 might be updated first, applying a slightly different summation mechanism, or applying a different threshold function. Variants such as this allow the update mechanism to be modified to provide a more natural order of updates, and to tailor the individual node updates to more accurately reflect the relevance within a given layer, though again, such variants are derivatives of the more general underlying mechanism.

Unlike other ranking schemes, the ranking of a particular node is determined by propagating a value through the graph, rather than performing a global ranking based on some fitness function, such as the random surfer model, which assigns a ranking based on the probability of access to each node in the graph. This is because, rather than determining a global value, aspects of the present invention rank nodes according to their relation to a particular node or set of nodes. A global ranking can, however, be calculated for all nodes in the graph by assigning an initial value to all nodes in the layered linked node database, and executing the update mechanism, though this is an atypical usage because of the large processing cost associated with such updates, especially in larger layered linked node databases, because of combinatorial explosion and iterative propagation of the values. Indeed, it is precisely these limitations of extant systems that the present invention provides an alternative to.

In a typical usage of the present invention, rankings are determined by taking only a small set of initial nodes, assigning a value to them, and then propagating those values based on the arcs between those nodes and other nodes in the layered linked node database. This makes the ranking mechanism more scalable than comparable ranking mechanisms, even for very large graphs, because the cost of calculating the node ranking is not a function of the order of the graph, but rather a function of the connectivity of the nodes within and between layers of the graph. In typical graphs associated with typical envisaged usage in determining the relevance based on social network graphs, the number of arcs will generally be below 150, though in extreme cases, the number might grow to 800 or more arcs per node (Kraut 1998). This is because, in typical social networks, the number of outbound connections from any particular node, be it a user, or a shared photograph, is small. So in even very large graphs, this allows node relevancy to be determined quickly and efficiently.

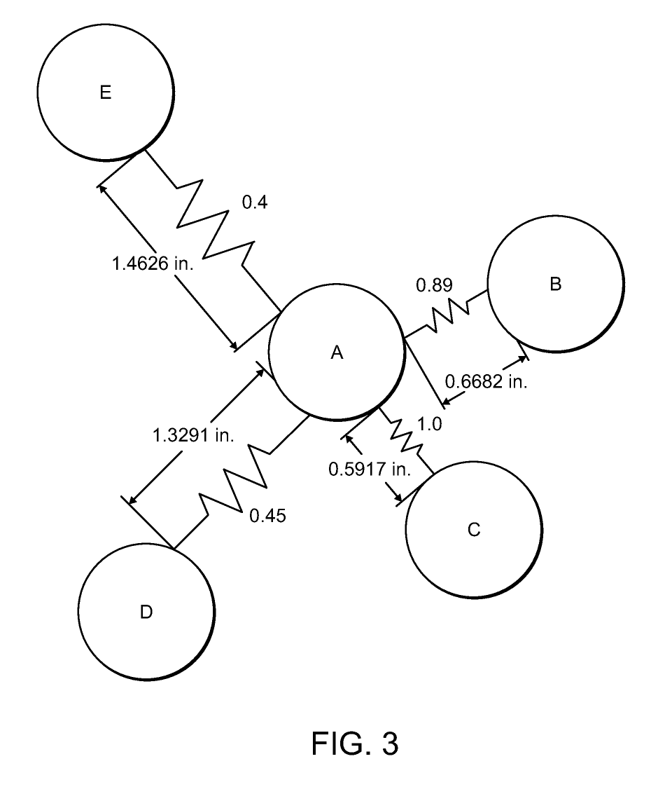

A further optimization may be applied: that of proximal weighting and pruning FIG. 3 shows an ideal representation of the concept of proximity in this mechanism, namely, that weights can be looked at as being inversely proportional to the distance. In FIG. 3, each node A thru E is assumed to be floating in space, and each node repels other nodes with equal intensity, and is connected to other nodes with a coil spring, acting as an attractive force countering the force repelling the nodes. In this ideal case, the relative strength of the spring determines the distance between nodes, and conversely, the spring strength is derivable from the distance, determining the strength of the connection. Proximal weighting can be used to determine relevance: closer nodes are considered to be of more direct relevance than nodes further away. Note that in the general case, the distance metric can be any metric that allows distance to be determined in an n-dimensional Euclidean space. For example, a distance can be calculated between individuals based on the similarity of interests, where each interest would be assigned a value, and the set of interests would form a point in an n-dimension space, where n is the number of interests. Note also that this provides a means to integrate both physical proximity and virtual proximity: physical proximity can be directly expressed as a set of weights in the node structure of the layered linked node database. A sorting using proximal weighting can be applied to a collected list of nodes and connections such that those things ‘nearest’ reflect also those that are most ‘relevant’. This mechanism is applied to virtual nodes in the layered linked node database. The above-described distance between nodes is a representation of virtual distance between virtual nodes, the virtual distance being representative of the strength of the connection between two virtual nodes.

Proximal pruning can be used in large graphs with a large fan-out to restrict the ranking to a particular sub-graph, while still remaining compatible with aspects of the present invention. The update mechanism is a slight variant of that outlined earlier, where the value is propagated within a layer, and a list of top ranked nodes is collected. This list of top ranked nodes is then used to propagate the value within the layered linked node database, rather than propagating rankings for all nodes. This has the effect of restricting the total number of nodes visited during the application of the update mechanism with the added risk of potentially missing some highly relevant nodes because the nodes have a large number of arcs, or highly weighted arcs in the pruned sub-graph. A further variant may also use only the strongest weighted connections to propagate node rankings, thereby even further pruning the graph. Proximal pruning may be applied within arbitrary layers, rather than to all layers.

Node rankings can be calculated relative to one or more nodes in the graph rather than globally. Further, these rankings can occur dynamically, rather than performing a static relevancy ranking. As noted earlier, this is possible because the number of nodes actually visited during the ranking process is typically constrained to a small local sub-graph, rather than the entire graph. By performing the ranking dynamically, changes can have an immediate effect on node rankings. For example, if the value of C1 in FIG. 4 were changed to a value of 0.5, the next ranking would assign a rank value of 0.5 to node B rather than the value of 0.75. Values can change, for example, based on machine learning; things that are ‘close’ have a higher weight, and as they move ‘closer,’ the weight will be increased. By dynamically calculating the ranking, the ranking system responds to local changes immediately, without the cost of global re-ranking, which makes aspects of the present invention not only more responsive, but also more scalable. This last point is particularly important for extremely large graphs: a large number of changes to graphs are possible because each change is local, and effects only a local sub-graph.

The dynamic nature of the node ranking calculation can be used to provide the system with a means to determine temporal relevancy of a node, or a degree of machine learning capability. The concept is best described by referring to FIG. 3, but where the springs, instead of having an ideal structure, with a fixed weight, are imperfect and subject to fatigue. This means that over time, the strength of the spring will decrease, eventually falling to some minimal value, and the distance between the nodes will increase. In the proximal weighting and pruning model, these nodes would, over time, become steadily less relevant and may even be eliminated altogether. This can be accomplished by degrading the values of the weights in a particular set of arcs every time a weight is updated. The derivative equation for determining a node ranking then becomes

$${N}_{i} = {\sum }_{j} {E}_{ij} {N}_{j} dt$$

where d is the decay factor, and t is time. This decay can be thought of as introducing to the system the ability to slowly ‘forget’ a relationship, and naturally models the mobile device users' own patterns.

Note that in addition to the decay factor, some updates may increase the weights of a given arc. For example, in FIG. 2, a general update rule might be that every time user (F4) visits a given place (P1), the weight of the connection is increased by 0.05, up to a maximum value. This has the effect of increasing the weight of the spring in FIG. 3, thereby decreasing the distance between nodes, and thereby increasing relevance. This capability can be exploited to dynamically learn and react to updates to actions by a mobile device user. For example, continual searches for Japanese restaurants may increase the strength of the weight on the arc from the user to the set of Japanese restaurants in the layered linked node database, or to the term ‘Japanese’. In the first case, it would result in Japanese restaurants being ranked higher, in terms of relevance, than other restaurants; in the later case, it might affect rankings for all things Japanese: it is reasonable to assume that someone who is interested in Japanese food may also be interested in Japanese movies. These are not mutually exclusive.

Referring to FIG. 8, the present invention, in a preferred embodiment, using multiple Data Storage units 806, a large in-memory virtual database 803, multiple nodes 804, multiple arcs 805, and multiple Ranking Analysis Engines 802, is a scalable, dynamic, temporally sensitive mechanism for determining relevancy of nodes in a layered linked node database. Unlike extant mechanisms, the system may be used with extremely large layered linked node databases with little impact on performance. Those skilled in the relevant art will note that the combination of strengthening and decaying connections allows the system to directly and naturally mirror the interests of the mobile device users 801. The strengthening and decay factors provide a degree of machine learning that automatically adjusts the relevancy of nodes according to local updates to the virtual database 803 that are immediately visible and usable by the Ranking Analysis Engine instances 802. In the context of mobile device users, those skilled in the relevant art will appreciate that the present invention represents a significant improvement over existing mechanisms by taking advantage of the ability for modern mobile devices to continually interact with the layered linked node database, and by taking advantage of the ability to determine the current location of the mobile device user. The system is sensitive to social, geospatial and temporal relevance.

Those skilled in the relevant art will further appreciate that the present invention is not constrained to use within the context of mobile devices. The mechanism is a generally applicable node ranking mechanism for large layered linked node databases with a significant number of variant applications. For example, the present invention is directly applicable to domains such as recommending relevant news articles, recommending products, or targeting advertisements. In all cases, the ability to represent the global aggregate ranking in a dynamic way improves upon the state of the art.

What is claimed:

1. A system for determining node relevancy by proximal weighting in a layered linked node database, the system comprising:
a layered linked node database with a plurality of linked layers including a geospatial layer representing physical locations, a place layer representing virtual locations, and a social layer representing a social network;
a plurality of virtual nodes within each layer, each virtual node representing an item; and
a plurality of inter-layer virtual arcs between virtual nodes in different layers, representing inter-layer node relationships, each inter-layer virtual arc having a weighting representative of a virtual distance between two virtual nodes

2. The system of claim 1, further comprising a plurality of intra-layer virtual arcs between virtual nodes within each layer, each intra-layer virtual arc representing intra-layer node relationships and having a weighting representative of a virtual distance between two virtual nodes

3. The system of claim 1, wherein at least one item is a contact, an establishment, or a geospatial location.

4. The system of claim 3, where the virtual nodes directly reflect the items within an online social network.

5. The system of claim 3, where the virtual arcs directly reflect the relationship between items within an online social network.

6. The system of claim 3, wherein each virtual node has relationships with less than 150 other virtual nodes.

7. The system of claim 3, wherein at least one virtual node has relationships with more than 800 other virtual nodes.

8. The system of claim 2, further comprising an update mechanism for updating the relevancy ranking of at least one virtual node.

9. The system of claim 8, further comprising an update mechanism for updating the relevancy ranking of at least one virtual arc.

10. A method of determining node relevancy by proximal weighting in a layered linked node database, the method comprising:
assigning initial values to a subset of virtual nodes within a layered linked node database, each virtual node contained within one of a plurality of linked layers in a database and representing an item; and
deriving a relevancy ranking for additional virtual nodes based on virtual arcs between a virtual node with an assigned value and additional virtual nodes, each virtual arc having a weighting representative of a virtual distance between the assigned value virtual node and one additional virtual node.

11. The method of claim 10, wherein the plurality of linked layers includes a geospatial layer representing physical locations, a place layer representing virtual locations, and a social layer representing a social network

12. The method of claim 11, wherein at least one item is a contact, a restaurant, or a geospatial location.

13. The method of claim 11, further comprising: adding a virtual arc, or updating the weight of a virtual arc based on external stimulus.

14. The method of claim 11, further comprising: updating the relevancy ranking for all virtual nodes in the layered links node database.

15. The method of claim 11, further comprising: updating the relevancy ranking for a subset of virtual nodes in the layered links node database in parallel using disjoint processes.

16. The method of claim 11, further comprising: pruning the relevancy ranking of a plurality of virtual nodes by ignoring virtual nodes that fall below a threshold value for ranking.

17. The method of claim 11, further comprising: pruning the relevancy ranking of a plurality of virtual nodes by ignoring virtual arcs that fall below a threshold weight value.

18. The method of claim 17, further comprising: degrading the values of the weighting of at least one virtual arc between each of the plurality of virtual nodes to be pruned and other virtual nodes as a function of time.

19. The method of claim 18, further comprising: degrading the values of the weighting of at least one virtual arc between each of the plurality of virtual nodes to be pruned and other virtual nodes as a function of time.

20. The method of claim 11, further comprising: removing at least one virtual arc as a function of at least one of time and connection strength.

21. A system for determining node relevancy by proximal weighting using a mobile device, the system comprising:
a layered linked node database with a plurality of linked layers including a geospatial layer representing physical locations, a place layer representing virtual locations, and a social layer representing a social network, the database accessible via a mobile device;
a plurality of virtual nodes within each layer, each virtual node representing an item, at least one item having been selected via the mobile device; and
a plurality of inter-layer virtual arcs between virtual nodes in different layers, representing inter-layer node relationships, each inter-layer virtual arc having a weighting representative of a virtual distance between two virtual nodes, at least one inter-layer virtual arc being represented to the user via the mobile device.

22. The system of claim 21, further comprising a plurality of intra-layer virtual arcs between virtual nodes within each layer, representing intra-layer node relationships, each intra-layer virtual arc having a weighting representative of a virtual distance between two virtual nodes, at least one intra-layer virtual arc being represented to a user via the mobile device.

23. The system of claim 22, further comprising an update mechanism for updating the relevancy ranking of at least one virtual node.

24. The system of claim 23, further comprising an update mechanism for updating the relevancy ranking of at least one virtual arc.

25. The system of claim 24, wherein at least one item is a contact, an establishment, or a geospatial location.

26. The system of claim 24, wherein each virtual node has relationships with less than 150 other virtual nodes.

27. The system of claim 24, wherein at least one virtual node has relationships with more than 800 other virtual nodes.

28. The system of claim 24, wherein at least one of the geospatial layer, the place layer, and the social layer is represented to a user via the mobile device.

29. The system of claim 24, wherein the geospatial layer, the place layer, and the social layer are each represented to a user via the mobile device.

30. The system of claim 28, wherein a plurality of relationships can be updated by the user via the mobile device.

31. The system of claim 28, wherein the virtual distance between at least two nodes changes as a function of time.

32. The system of claim 31, wherein the change in virtual distance is in response to action by the user, communicated via the mobile device.

33. The system of claim 31, wherein the change in virtual distance is in response to inaction by the user.

34. A system for determining node relevancy by proximal weighting in a layered linked node database, the system comprising:
a layered linked node database with a plurality of linked layers including a geospatial layer representing physical locations, a place layer representing virtual locations, and a social layer representing a social network;
a plurality of virtual nodes within each layer, each virtual node representing an item;
a plurality of intra-layer virtual arcs between virtual nodes within each layer, representing intra-layer node relationships, each intra-layer virtual arc having a weighting representative of a virtual distance between two virtual nodes; and
a plurality of inter-layer virtual arcs between virtual nodes in different layers, representing inter-layer node relationships, each inter-layer virtual arc having a weighting representative of a virtual distance between two virtual nodes.

35. A system for determining node relevancy by proximal weighting using a mobile device, the system comprising:
a layered linked node database with a plurality of linked layers including a geospatial layer representing physical locations, a place layer representing virtual locations, and a social layer representing a social network, the database accessible via a mobile device;
a plurality of virtual nodes within each layer, each virtual node representing an item, at least one item having been selected via the mobile device;
a plurality of intra-layer virtual arcs between virtual nodes within each layer, representing intra-layer node relationships, each intra-layer virtual arc having a weighting representative of a virtual distance between two virtual nodes, at least one intra-layer virtual arc being represented to a user via the mobile device; and
a plurality of inter-layer virtual arcs between virtual nodes in different layers, representing inter-layer node relationships, each inter-layer virtual arc having a weighting representative of a virtual distance between two virtual nodes, at least one inter-layer virtual arc being represented to the user via the mobile device.
